(19) United States
(12) Patent Application Publication
(10) Pub. No.: US 2009/0031959 A1
(43) Pub. Date: Feb. 5, 2009

(54) Convertible Pet Bed

(76) Inventor: Pi Kathleen Crowley, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/171,131

(22) Filed: Jul. 10, 2008

Related U.S. Application Data
(60) Provisional application No. 60/948,859, filed on Jul. 10, 2007.

(51) Int. Cl. A01K 29/00

(52) U.S. Cl. 119/28.5

(57) ABSTRACT

A pet bed comprises a pad having seams along its edges, which permit the edges to be folded up and tied at the corners. In this manner, the pet bed may be converted back and forth between flat and closed-sided configurations.

### RELATED PATENT APPLICATION

This application claims the benefit of U.S. Provisional Application No. 60/948,859, filed Jul. 10, 2007 and entitled “CONVERTIBLE PET BED.”

### TECHNICAL FIELD OF THE INVENTION

This invention relates to pads used as bedding for pets, such as cats and dogs.

### BACKGROUND OF THE INVENTION

Dog and cat beds come in a vast variety of shapes, sizes, and designs. Some designs are simply pads that lie flat on the floor, whereas others have sides as well as a bottom. The choice between these two designs (flat or closed-sided) depends in large part on the animal's comfort as well as how the pad is to be used. The choice between a flat or closed-sided design may depend on whether the pet bed is to be used in a carrier or crate, in a vehicle, inside a hard pet bed, or on the floor or furniture.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a perspective view of the pet bed in the flat configuration.

FIG. 2 is a perspective view of the pet bed in the closed-sided configuration.

FIG. 3 is a perspective view of an alternative embodiment of the pet bed.

FIGS. 4A-4F illustrate the use of the corner ties to tie the pet bed from the flat to the closed-sided configuration.

### DETAILED DESCRIPTION OF THE INVENTION

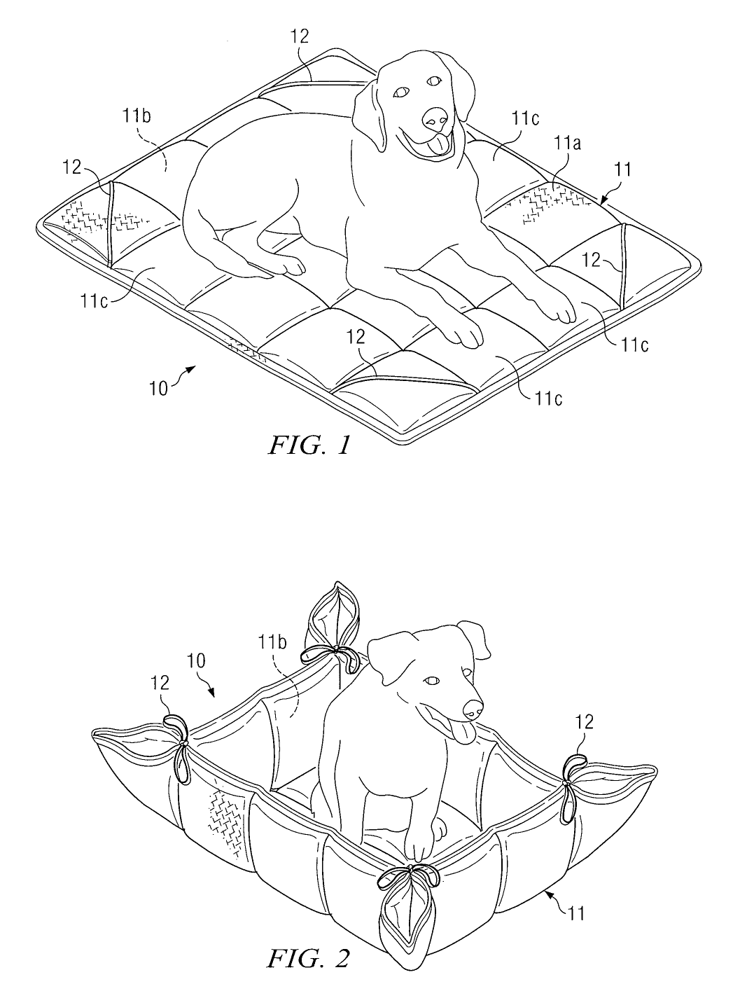

FIG. 1 is a perspective view of the pet bed 10 in the flat configuration. FIG. 2 is a perspective view of the pet bed 10 in the closed-sided configuration. As explained below, pet bed 10 comprises a rectangular pad 11 having a tie 12 at each corner.

Pad 11 has a fabric covering 11a enclosing a compressible filling 11b (not shown). The filling may be of various soft materials, including but not limited to foam in a solid piece or in small pieces used as stuffing. An example of a suitable filling is soft polyfill. The thickness of the filling may vary, but is typically about an inch, and as explained below, is sufficiently thin to permit the sides of pad 11 to be folded up and tied at the corners.

Pad 11 is quilted in a pattern of rows and columns of square sections 11c. The size of the sections can vary, with a typical size of each square being 3-8 inches. When bed 10 is in the closed-sided configuration, the outer rows and columns are folded up.

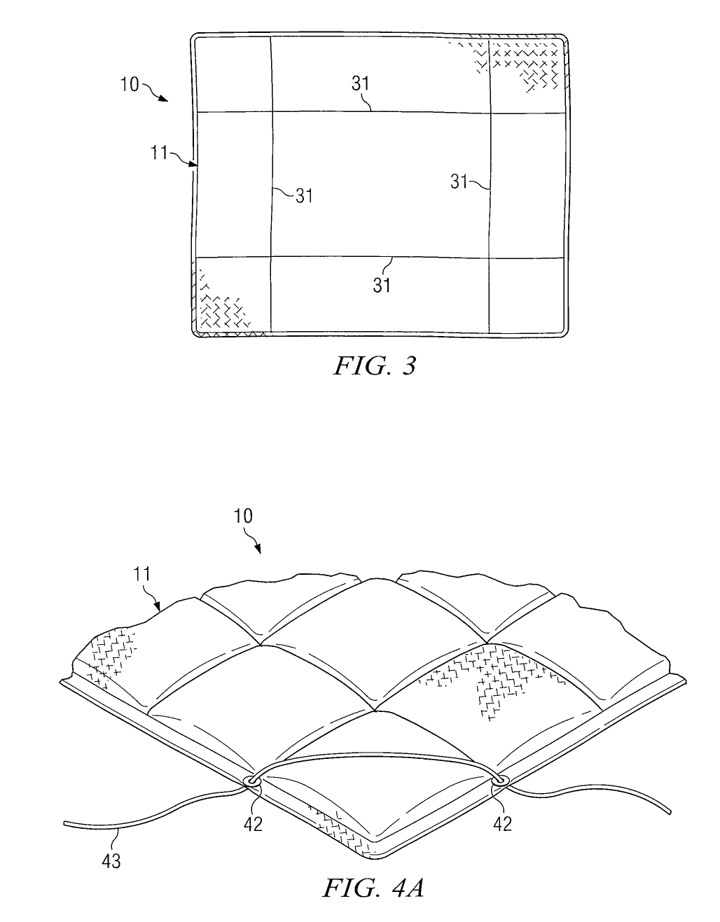

FIG. 3 illustrates an alternative embodiment, in which pad 11 has seams 31 spaced inward from its outer perimeter. A typical spacing from the perimeter is 3-8 inches. The seams facilitate folding of the pad 11. In the closed-sided configuration, the edges of pad 11 are folded upward along the seams. The area inside the seams could be quilted in any pattern or not quilted at all.

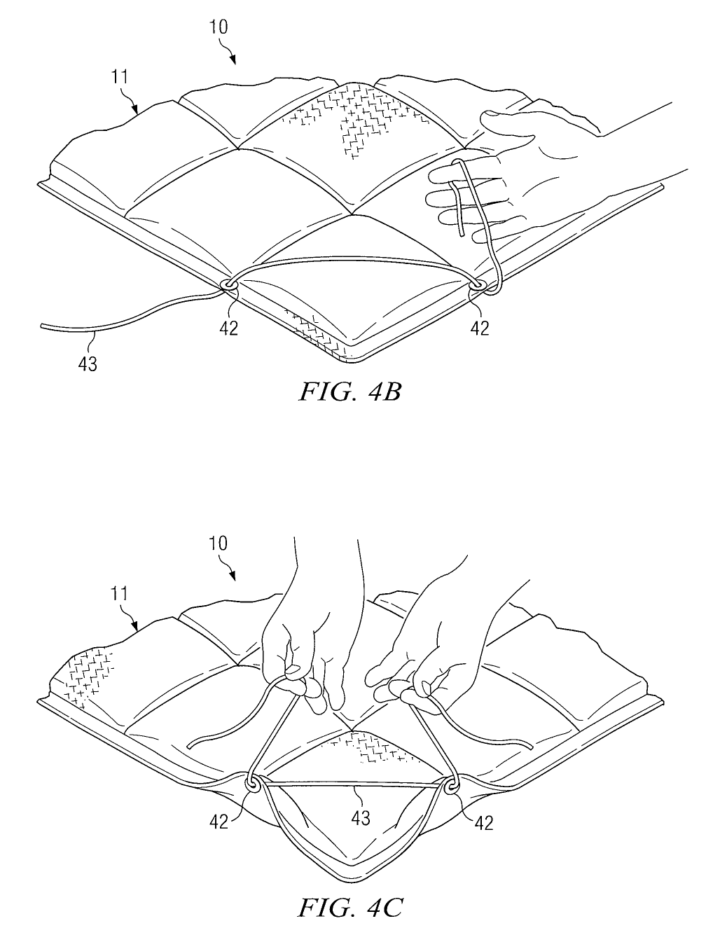

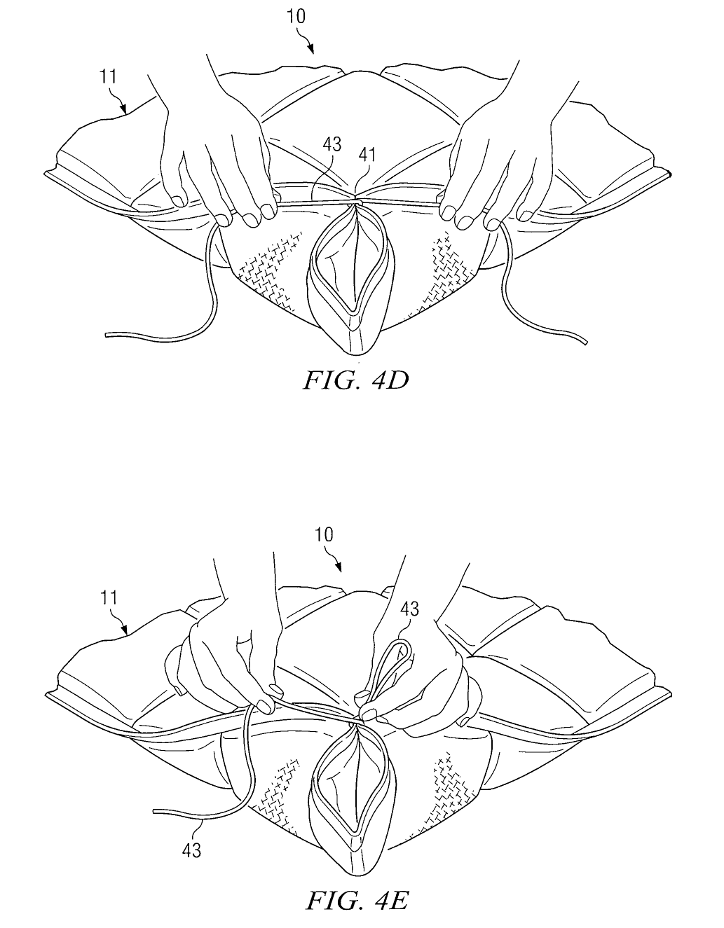

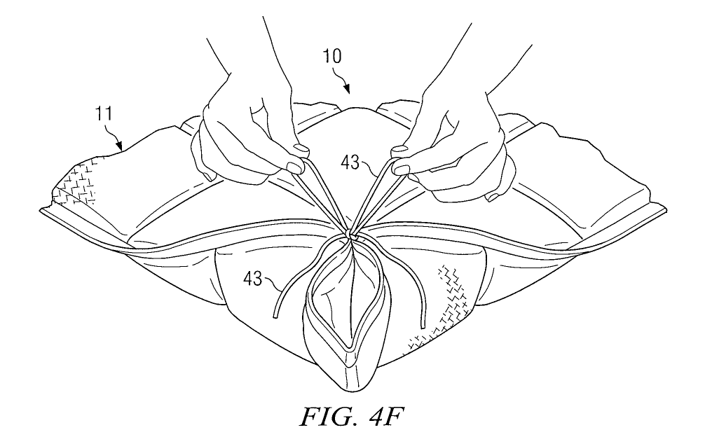

As illustrated in FIGS. 4A-4F, pad 11 may be tied at each corner to convert bed 10 from a flat to a closed-sided configuration. A pair of ties 12 is fastened to each corner of pad 11. Each tie 12 is fastened at the perimeter of pad 11 at the outermost seam.

Ties 12 are made from any durable cordlike material. If desired, a pair of ties may be pieces of a single length of cord laid across a corner and secured at two edges of pad 11 as shown in FIG. 4A. The material from which ties are made must be sufficiently durable to withstand repeated tying and untying.

In the embodiment of FIG. 4A, each corner of pad 11 has a pair of grommets 42. These grommets 42 permit the ties 12 to be made from a single piece of cord 43, which is laid atop pad 11. Each end of cord 43 is then drawn through one of the grommets 42. The ends of cord 43 may then be easily tied together. The use of grommets 42 rather than a fixed attachment for ties 12 permits ties 12 to be easily replaced. For example, the ties 12 at each corner of pad 11 may be made from a shoestring.

As shown in FIGS. 4B and 4C, the user may close the ties, corner by corner, for one, two, three, or all four corners of bed 10. Each corner is closed by pulling the two ties at that corner toward each other such that the pulling action on the sides of pad 11 connected to the ties raises those sides to a vertical position. The ties are pulled until the two sides join at a point. A new inner corner 41 is formed within pad 11. The outermost corner of pad 11 is now folded outside the newly closed sides.

Next, as shown in FIGS. 4D-4F, the ties are secured together with a knot. An example of a suitable knot is a “shoelace” type knot, which can be easily untied.

Referring again to FIGS. 1 and 2, the material used for covering 11a is selected for durability and easy cleaning. An example of a suitable material is a woven acrylic fiber. The material used for both covering 11a and filling 11b may be of a type that will permit the entire pet bed 10 to be washed in a washing machine.

The overall dimensions of pet bed may vary, but for dogs and cats, a typical range of dimensions is 24-42 inches. The shape may be rectangular or square, depending on the size and shape of the animal with which the bed is to be used.

It should be noted that any one or more of the corners can be tied to form two or more raised sides. In other words, it is not necessary that all four corners be tied together. For example, only one corner could be tied.

1. A bed for small animal pets, comprising:
a rectangular pad, the pad being quilted in a pattern of rows and columns and filled with a padding material;
wherein the rows and columns are defined by seams;
wherein the pad is foldable along the outermost seam of the respective row or column around its perimeter, to form a four-sided enclosure configuration;
a pair of grommets at each corner of the pad;
wherein the pad is operable to be tied with cord at any two or more of its corners by stringing the cord through the grommets, thereby securing the pad in a raised-sided configuration, and is further operable to be untied thereby forming a flattened configuration.
